(19) United States
(12) Patent Application Publication
(10) Pub. No.: US 2012/0145304 A1
(43) Pub. Date: Jun. 14, 2012

(54) REMOVABLE LABEL FOR CONTAINERS

(75) Inventors: Noel Mitchell, Wuppertal (DE); Kati Metsäjoki, Pirkkala (FI)

(73) Assignee: UPM RAFLATAC OY, Tampere (FI)

(21) Appl. No.: 13/391,422

(22) PCT Filed: Aug. 19, 2010
(86) PCT No.: PCT/FI2010/050656

§ 371 Date: Feb. 21, 2012

Related U.S. Application Data
(60) Provisional application No. 61/235,027, filed on Aug. 19, 2009.

(51) Int. Cl. B32B 37/02; B32B 7/06; B32B 27/08

(52) U.S. Cl. 156/60; 428/354; 428/335

(57) ABSTRACT

A label having a laminated composite structure and including an adhesive layer, a polypropylene film and a lactic acid based polymer film. The adhesive layer is on a first side of the polypropylene film and a lactic acid based polymer film is on a second side of the polypropylene film. The lactic acid based polymer film induces curling so that the label is removable during washing process from a surface of an item attached.

### CROSS REFERENCE TO RELATED APPLICATIONS

This application claims priority from U.S. provisional application No 61/235,027 filed Aug. 19, 2009.

### FIELD OF THE INVENTION

The present invention relates to a composite structure of a laminate and easily removable labels made thereof, and more particularly, to wash-off pressure-sensitive labels for use on reusable containers.

### BACKGROUND OF THE INVENTION

It is general practice to apply labels to the surface of the containers, like bottles from polymer or glass, to provide decoration, identification, and/or information such as contents of the container. Plastic labels, in contrast to paper labels, are increasingly preferred, for example due to their more appealing appearance (for example transparency) and better mechanical properties. The containers, like bottles in the beverage industry, are generally reused many times and thus there is a need for plastic labels which are easily and completely removed from the surface of the container during the conventional washing processes such as dilute caustic soda heated to 50-90° C.

Removable plastic labels known from prior art have been based on washing process soluble adhesive compositions, water permeable label films to aid dissolving the adhesives during washing, heat-shrinkable label films or label constructions consisting different material layers having different coefficient of thermal expansion and thus curling or reversibly curling under elevated temperature of the washing process to aid label removal.

U.S. Pat. No. 6,680,097 discloses a wash-off label construction comprising an adhesive layer for bonding the label to the article laminated with a stretched, non-thermally fixed plastic film layer such as mono- or biaxially oriented heat-shrinkable polyester (PET) or polyvinylchloride film (PVC) showing high degree of shrinkage. Under the typical washing conditions of 80-85° C. in an alkaline solution containing between 1-4% caustic soda, the base PVC or PET heat-shrinkable film of such a construction shrinks severely causing the whole label to curl allowing the caustic solution to affect the adhesive with the result that the adhesive and the label detaches from the bottle. The bottles in this case could be typically either glass or polyester.

In general, known wash-off label constructions typically also contain print layer(s), preferably covered with a transparent protective layer such as lacquer or laminated film. Printed layer may also be for example, a reverse printed film such as a polypropylene film. In reverse printed film the printing is carried out on the reverse side of the film prior to coating with a laminating adhesive and laminating onto the base laminate structure.

The major deficiencies of these conventional type wash-off label constructions are that they are rather costly and in addition in some cases they are using environmentally unfriendly PVC solutions. In the environmental point of view, label materials from renewable resources would be preferred.

### SUMMARY OF THE INVENTION

It is an object of the present invention to provide a laminated composite construction for wash-off labels used in labelling of reusable containers, such as glass and plastic bottles, that is not only more economic than existing solutions, but also environmentally friendly comprising a biodegradable polylactic acid (PLA) polymer from renewable resources. Further object is to provide laminates for labels with good printing and dispensing properties.

According to a first aspect of the invention there is provided a pressure-sensitive laminate for wash-off labels having a composite base structure, which comprises a polypropylene film as an upper layer. On top of the polypropylene film there is a lactic acid based polymer, polylactide, film as an overlaminating film layer.

According to an advantageous embodiment of the invention both the polypropylene film and polylactide film are biaxially oriented, transparent and non-shrinkable at elevated temperatures.

According to another advantageous embodiment of the invention the laminated label structure of polypropylene and polylactide films with an adhesive layer is non-shrinkable at elevated temperatures.

According to an advantageous embodiment of the invention dimensional changes of the non-shrinkable films and laminated label structure are less than 5%.

According to an advantageous embodiment of the invention the lactic acid based polymer film is a corn-starch based polylactide.

According to one embodiment of the invention the polypropylene film of the composite base structure is used as a print substrate layer and the polylactide film is used as a protective layer and an active layer.

According to another embodiment of the invention the polylactide film is used as a print substrate layer, a protective layer and an active layer.

According to an advantageous embodiment of the invention the polylactide film has a thickness from 20 to 50 microns, preferably 20 or 40 microns.

According to another aspect of the invention the wash-off label has a structure laminated from at least two films of different polymers and at least one of the films consisting of lactic acid based polymer curling under the effect of hot washing liquid. The curling of the lactic acid based polymer film is due to portions of the amorphous chains in the polymer which are crystallizing and causing changes in the dimensional stability of the film. Curling and label removal may also be aided by swelling of the lactic acid based polymer film due to the moisture absorption.

According to further aspect of the invention the wash-off label is used for labelling of reusable containers.

Polylactide material has benefit due to its eco-friendly nature like development from renewable materials and biodegradability. Polylactide PLA is a biodegradable, thermoplastic, aliphatic polyester derived from lactic acid obtained from renewable or non-renewable resources. It can be processed in similar manner than many thermoplastics into fibres, films or other products manufactured by conventional melt processing techniques. Due to the chiral nature of lactic acid and different cyclic diesters, lactide stereoisomers, several distinct forms of polylactide exists such as homopolymer of L-lactide PLLA and stereocopolymers of L-lactide and D-lactide P(L/D)LA or L-lactide and DL-lactide P(L/DL)LA.

### DESCRIPTION OF THE DRAWINGS

The present invention will be explained below, with reference to accompanying drawings, wherein

FIG. 1 shows a cross-sectional view of a laminated composite construction for labels according to an example embodiment of the invention,

FIG. 2a is a cross-sectional view of a printed and overlaminated polypropylene film according to an example embodiment of the invention, and

FIG. 2b is a cross-sectional view of a printed polylactide film according to an example embodiment of the invention.

### DETAILED DESCRIPTION OF THE INVENTION

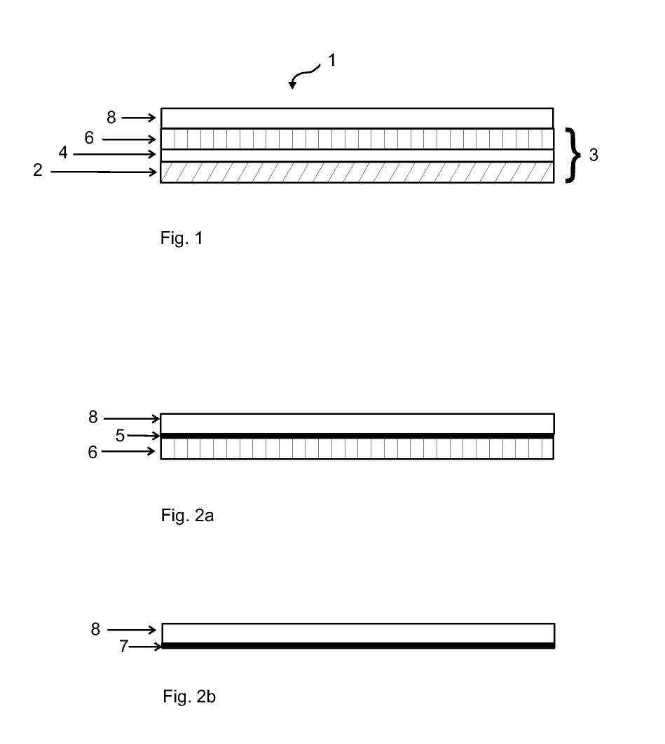

According to one example embodiment of the invention, as presented in FIG. 1, a laminated composite construction 1 for labels comprises a synthetic liner 2, preferably polyester, on to one side of which a coating of release agent, preferably silicone, is applied. This release liner is then further coated with a pressure-sensitive adhesive layer 4 to which a polypropylene film 6, preferably in a thickness between 15-50 microns, is laminated. Preferably the polypropylene is a biaxially oriented (BOPP), transparent and non-shrinkable film. In this application non-shrinkable means that neither the plastic film nor a structure laminated from different plastic films are shrinkable at elevated temperature (heat-shrinkable) and have an average dimensional change substantially less than 5% at temperatures between 65 to 90° C., even in wet conditions.

After removal of the liner the label can be attached to the surface of an item through an adhesive layer. The adhesive used here is such that the label is capable of being washed off. Preferably the adhesive is such that under the influence of the washing liquid and temperature it loses its adhesivity to some degree but does not become soluble into the washing liquid. Therefore, the washing liquid does not become contaminated with the adhesive. The above described liner/release agent/adhesive/polypropylene film structure 3, also referred as a base laminate structure or composite base structure hereinafter, may further be printed directly on the upper surface, also called as a top surface, of the polypropylene film by any of the known printing methods, however preferably by gravure or flexographic processes. Thus polypropylene film is serving as a print substrate layer. FIG. 2a shows the polypropylene film layer 6 of a base laminate structure having a print layer 5 on upper surface. After printing, the polypropylene film 6 is overlaminated with a polylactide (PLA) film 8 of a thickness between 20-50 microns. The PLA film overlying the printed PP layer is a biaxially oriented, transparent and non-shrinkable PLA film. The laminated structure comprising a polypropylene film overlaminated by a polylactide film will be designated also as a facestock hereinafter. Overlamination means the placing together material layers, such as separate plastic film layers, by means of a suitable surface treatment of the films, primer or lamination adhesive between the layers.

The PLA layer 8 is provided on the upper surface of the base laminate structure 3 in order to protect the printed PP layer 6 and may be thus called as a protective layer. The labels are then die-cut from the laminated composite construction and later applied on to the surface of the items like bottles or other containers.

According to another example embodiment of the invention, as presented in FIG. 2b, the PLA film 8 is used as a print substrate layer. The PLA film will be printed on the reverse-side, lower surface of the film, instead of printing on the upper surface of the polypropylene film. Then this printed side of the PLA film 7 is laminated to the polypropylene layer of base laminate structure with a laminating adhesive, preferably of polyurethane basis. PLA film may be thus both a print substrate and a protective layer. Also in this case, the labels are further die-cut and later applied to the bottles or other containers. According to an advantageous embodiment of the invention, the base laminate structure 3 for labels comprises a polyester (PET) release liner having a thickness of 25 microns, a pressure-sensitive adhesive layer, and a biaxially oriented polypropylene (PP) layer having a thickness of 25 microns. This base laminate structure is further overlaminated by a 40 micron biaxially oriented PLA film. PLA film is serving as a protective layer and/or print layer overlying the PP layer. It is also possible to use PLA overlaminating film layer having a thickness of 20 microns.

According to further embodiment of the invention the laminated composite construction comprises two separate print substrate layers, which layers consists films of different polymers. The printing may be arranged, for example, both on the upper surface of the polypropylene film and the reverse side of PLA film which films are then laminated together printed surfaces against each other. There will be no printing ink on the top/upper surface of the laminate construction. The PLA film is thus used as a print substrate and a protective layer for the laminated composite structure. In some applications, using two separate print substrate layers consisting of different polymers may be beneficial, and permit use of different type of printing methods and/or inks and allow excellent printing properties for the label.

According to the invention the lactic acid based polymer film (PLA) is a polylactide of a corn-starch based lactic acid. Polylactide has initially partially crystalline structure containing both crystalline and amorphous regions. Polylactide may also be totally amorphous.

Labels according to the invention can be used for labelling different type of containers, typically reusable containers such as beverage containers such as bottles, in particular glass or plastic bottles for soft drinks or beer.

Labels produced in the above described manner having laminated composite structure are suitable to be washed off in the standard bottle washing conditions at temperatures between 65-90° C., preferably at 80° C.

According to the one embodiment of the invention there is provided a wash-off label having a laminated facestock structure comprising at least two plastic film layers of different polymers. At least one of these plastic film layers comprises an active polylactide layer consisting of a lactic acid based polymer that is arranged to curl under the washing conditions. According to the test results the PLA layer acts as an active layer inducing curling and removal of the label. The understanding of the underlying phenomena is that this curling takes place due to the amorphous regions of the polylactide structure which are able to crystallize under the washing conditions. Curling and label removal may also be aided by swelling of the lactic acid based polymer film due to the moisture absorption.

According to the present invention, the above described laminated composite structure of the labels will also have excellent printing and dispensing properties. For example, two distinct print substrate layers having different polymeric films will allow more possibilities to select printing techniques and/or inks and thus increase abilities to modify the visual appearance of the labels. Due to the laminated composite structure the labels will have good applicability during the removal of the label from the liner and application of the label to the substrate surface.

In the following, the present invention will further be described by means of some examples, which do not restrict the scope of the invention.

### EXAMPLE 1

In practical washing tests carried out at a temperature of 80° C. in a 1.5% dilute caustic soda solution, it has been observed that label samples produced in the manner described above are washable from the bottles in times of less than 60 seconds, which matches perfectly with practical requirements of the washing processes.

According to the invention, neither the individual biaxially oriented plastic films nor the laminated label structure comprising at least two plastic film layers of different polymers are heat-shrinkable i.e. significantly shrinkable at elevated temperatures. However the laminated structure comprising both biaxially oriented polypropylene and polylactide films will curl notably during washing process in a water bath at 80° C., allowing the caustic solution to reduce the adhesion of the adhesive and remove the label form the surface attached.

It was observed in MDSC (modulated differential scanning calorimeter) measurements that an exothermic reaction takes place in PLA polymer above the glass transition of approximately 60° C., and in the range of 60-80° C. Under these conditions it seems that portions of the amorphous chains in the PLA polymer are crystallizing which cause changes in the dimensional stability of the labels. These changes in dimensional stability are normally of the order of approximately 1-3%. In addition due to the high water absorption property of the PLA film, there is a positive change in the thickness of the film. These changes in the PLA film result in a curling of the sample labels which then enables the caustic soda solution to wash the labels off from the bottle surface. Therefore, in the laminated label construction according to the invention, the overlaminating PLA layer acts as an active layer inducing necessary curling leading to removal of the label via letting the washing liquid to affect the adhesive.

### EXAMPLE 2

Samples made of PP film having thickness of 25 μm, PLA film having thickness of 20 or 40 μm and laminated composite construction of PP 25 μm overlaminated by PLA 40 μm were immersed in water of 80° C. for 5 minutes. All the plastic films were biaxially oriented. Dimensional changes of the samples were defined through measuring the dimensions of the samples before and after water immersion.

All samples comprising polylactide film were observed to curl upwards, that is in the case of labels away from the adhesive-coated side. This curling behaviour was observed to be irreversible, that is, the samples remained curled even after the temperature of the film was returned to normal room temperature. The plain PP film was observed not to curl.

According to the measurements and tests done, dimensional changes in machine direction and transversal direction of the samples were small, as presented in table 1 below. The positive thickness change of the samples was observed, which is most likely due to the water absorption of the films.

TABLE 1
Dimensional changes of the plastic film samples.

| | Dimensional | Dimensional | Thickness |
|---|---|---|---|
| Sample | change, MD (%) | change, TD (%) | change (%) |
| PP 25 microns | −0.2 | 0.2 | 1.6 |
| PLA 20 microns | −3.6 | −4.0 | 1.8 |
| PLA 40 microns | −3.3 | −3.3 | 1.9 |
| Laminate of PLA | −2.8 | −1.8 | 1.2 |
| 40 microns/PP25 | | | |
| microns | | | |

Based on the MDSC (modulated differential scanning calorimeter) measurements, the polylactide is initially partially crystalline and the curling of the PLA containing samples was observed to take place above glass transition temperature T_{g} of the polylactide film. It was also observed exothermic transition(s) to occur around 60-80° C. The curling of the non-shrinkable PLA films, laminates including PLA layer and the labels made thereof, may be a consequence of different changes in PLA properties and morphology under the washing conditions. Thus overlaminating PLA layer is acting as an active layer during the removal of the labels. Portions of the amorphous chains in the polylactide are crystallising causing small changes in the morphology and dimensional stability of the films. There occurs also some relaxation of the oriented polymer chains. These changes, alone or in combination, together with the positive thickness changes due to moisture absorption may result in the curling and subsequent washing behaviour and removal of the labels.

1. A label having a laminated composite structure comprising:
an adhesive layer,
a polypropylene film, and
a lactic acid based polymer film,
wherein the adhesive layer is on a first side of the polypropylene film, wherein the lactic acid based polymer film is on a second side of the polypropylene film, and wherein the lactic acid based polymer film induces curling so that the label is removable during washing process from a surface of an item attached.

2. The label according to claim 1, wherein the polypropylene film and lactic acid based polymer film are biaxially oriented.

3. The label according to claim 1, wherein the lactic acid based polymer film is a corn-starch based polylactide.

4. The label according to claim 1, wherein the polypropylene film is a print substrate layer.

5. The label according to claim 1, wherein the lactic acid based polymer film is suitable for at least one of the following:
an active layer,
a protective layer or a print substrate layer.

6. The label according to claim 1, wherein the lactic acid based polymer film has a thickness from 20 to 50 microns.

7. The label according to claim 1, wherein the films of polypropylene and lactic acid based polymer are non-shrinkable.

8. The label according to claim 7, wherein the dimensional changes of the films are less than 5%.

9. The label according to claim 1, wherein the label is non-shrinkable.

10. The label according to claim 9, wherein the dimensional changes of the label are less than 5%.

11. The label according to claim 1, wherein the lactic acid based polymer film curls under the washing conditions having a temperature between 65 and 90° C.

12. A wash-off label according to claim 11, wherein the curling of the lactic acid based polymer film takes place due to portions of the amorphous chains in the polymer to crystallize causing changes in the dimensional stability of the film.

13. A method for labelling of reusable containers, the method comprising:
providing a polypropylene film;
providing an adhesive layer on a first side of the polypropylene film;
providing a lactic acid based polymer film on a second side of the polypropylene film, wherein the lactic acid based polymer film induces curling so that the label is removable during washing process from a surface of an item attached; and
applying the label to reusable containers.

14. The label according to claim 6, wherein the lactic acid based polymer film has a thickness from 20 to 40 microns.
